(19) United States
(12) Patent Application Publication
(10) Pub. No.: US 2018/0178365 A1
(43) Pub. Date: Jun. 28, 2018

(54) ELECTRIC STAPLER

(71) Applicant: APEX MFG. CO., LTD., Taichung City (TW)

(72) Inventors: Py-Yi CHANG, Taichung City (TW); Chia-Tse CHEN, Taichung City (TW)

(21) Appl. No.: 15/392,543

(22) Filed: Dec. 28, 2016

(51) Int. Cl. B25C 5/02

(52) U.S. Cl. CPC B25C 5/0228

(57) ABSTRACT

The electric stapler includes a main body, a striking device, a photoelectric switch, a pivot element, and a triggering element. The striking device arranged in the main body includes a movable striking mechanism. The striking mechanism tends to stay at an original position. The photoelectric switch is connected to the striking device. An end of the pivot element is pivotally disposed on the main body, and the other end has a pushing portion. The pivot element tends to stay at a first position due to an elastic means. The triggering element movably arranged between the photoelectric switch and the pushing portion tends to stay at a reset position. When an abutting portion of the pivot element is pushed by papersheets, the pivot element pushes the triggering element to a triggering position, and the photoelectric switch is triggered so that the striking mechanism strikes a nail out.

### BACKGROUND OF THE INVENTION

### Field of the Invention

The present invention relates to an electric stapler, especially to an automatic electric stapler.

### Description of the Prior Art

A conventional electric stapler is shown in patent TW 577378. A button or triggering piece is arranged inside the opening of the stapler. When a papersheet is inserted into the opening, the papersheet pushes the button to trigger a switch. Thus, a striking device of the stapler strikes a nail out.

However, the button is under an elastic force by elastic element or others. That is, the papersheet has to push the button strongly to overcome the elastic force, so the front edge of the papersheet may be folded or curled. As a result, the position of the nail may be deviated.

Besides, the button, which corresponds to the front edge of the papersheet, and the striking portion, which corresponds to the position of the nail, are too close to each other. Thus, the button is possible to be damaged when the striking portion strikes the nail out.

### SUMMARY OF THE INVENTION

The main object of the present invention is to provide an electric stapler which is able to sense the papersheet and to strike the nail out automatically. In addition, the photoelectric switch may not be damaged by the striking device.

To achieve the above and other objects, an electric stapler of the present invention includes a main body, a striking device, a photoelectric switch, a pivot element and a triggering element.

The main body encloses a receiving space and has a front opening. The striking device is arranged in the receiving space and includes a movable striking mechanism. The striking mechanism is movable between an original position and a striking position. The striking mechanism tends to retain at the original position. The striking mechanism has a striking portion. The photoelectric switch is arranged in the receiving space of the main body and is connected to the striking device. The photoelectric switch triggers the striking mechanism to move to the striking position to drive the striking portion to strike a nail out when the photoelectric switch is triggered. An end thereof is pivotally connected to the main body near the front opening, and an other end thereof has a pushing portion. The pivot element is more remote from the front opening of the main body than the striking portion is. The pivot portion has an abutting portion at a face thereof facing the front opening. The pivot element is pivotable between a first position and a second position about a pivot axis. The pushing portion is closer to the front opening when the pivot element is located at the first position. The pushing portion is more remote from the front opening when the pivot element is located at the second position. The pivot element tends to retain at the first position due to an elastic force of an elastic member. The triggering element is movably arranged between the photoelectric switch and the pushing portion of the pivot element. The triggering element is movable between a reset position and a triggering position. The triggering element tends to retain at the reset position. The triggering element is pushed to move toward the triggering position when the abutting portion of the pivot element is pushed by a papersheet and the pivot element is moved toward the second position. The triggering element triggers the photoelectric switch when the triggering element is located at the triggering position.

Thereby, when the papersheet is inserted into the front opening and pushes the pivot element, the pivot element pushes the triggering element to trigger the photoelectric switch so that the striking mechanism moves downward to strike the nail out. Besides, the photoelectric switch may not be damaged by the moving striking mechanism.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of the present invention;

FIG. 2 is a breakdown drawing of the present invention;

FIG. 3 is a partial breakdown drawing of the present invention;

FIG. 4 is a cross-section of A-A of the present invention;

FIG. 5 is an illustration of the present invention;

FIG. 6 is a cross-section of B-B of the present invention;

FIG. 7 is a partial enlargement of FIG. 6;

FIG. 8 is an illustration of the present invention;

FIG. 9 is an illustration of the present invention.

### DETAILED DESCRIPTION OF THE PREFERRED EMBODIMENTS

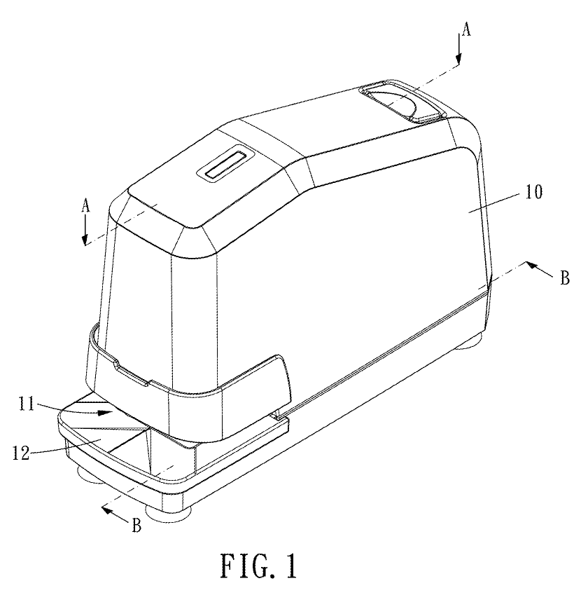

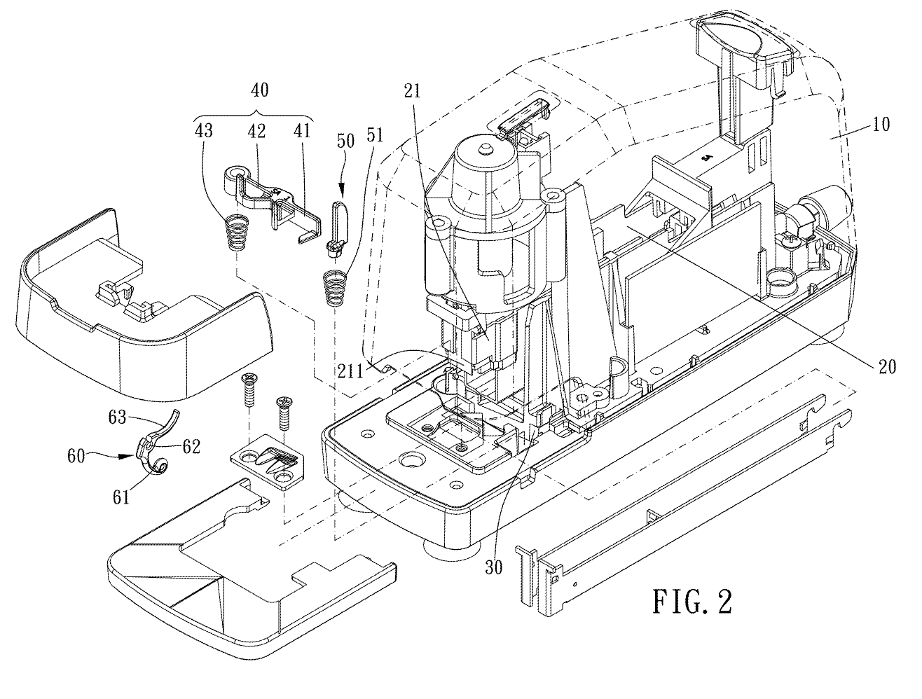

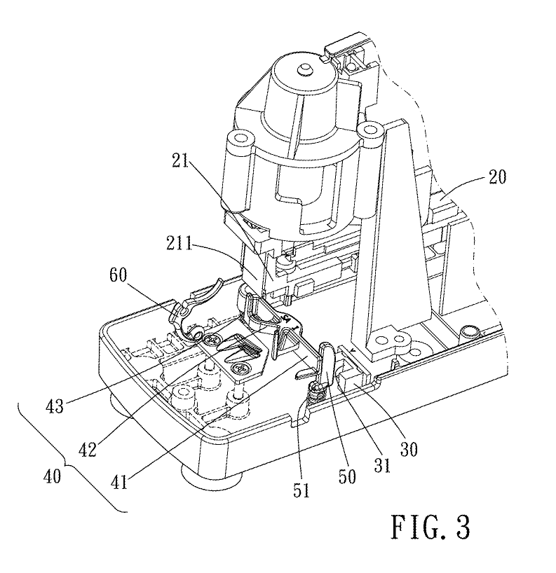

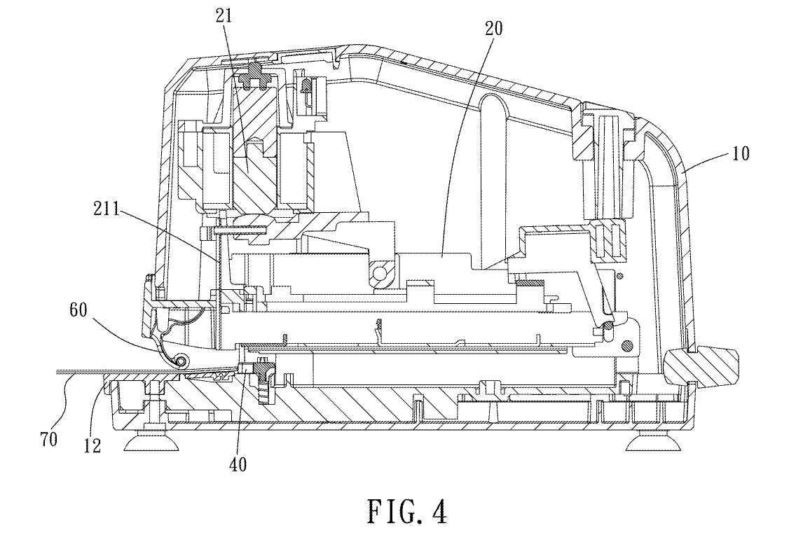

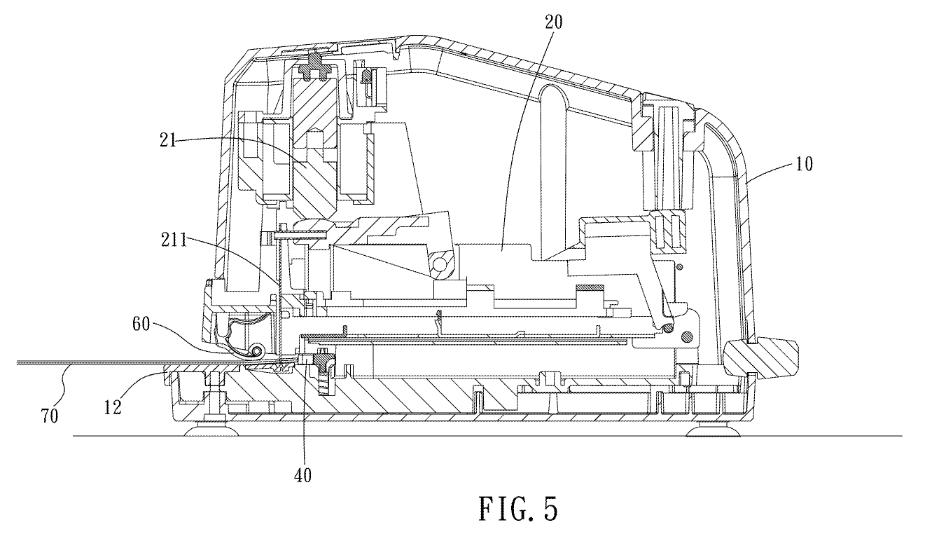

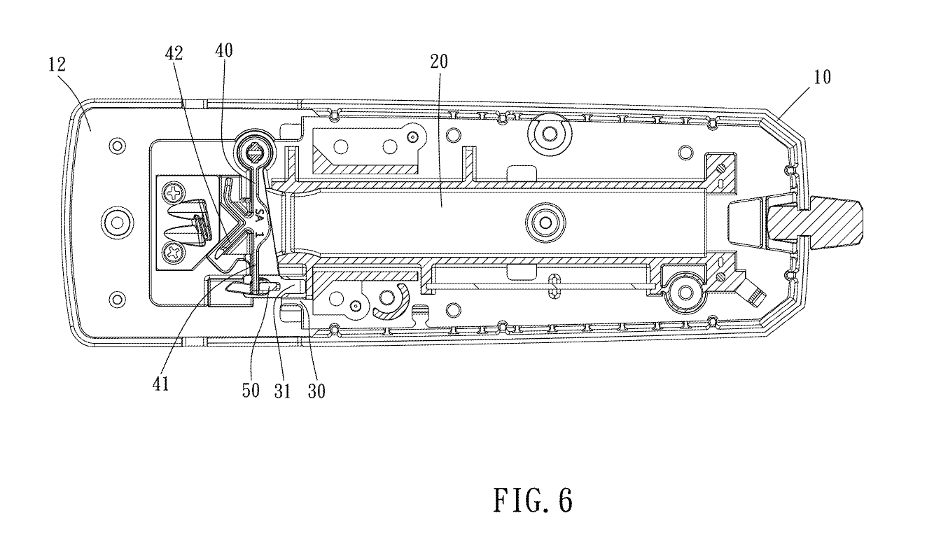

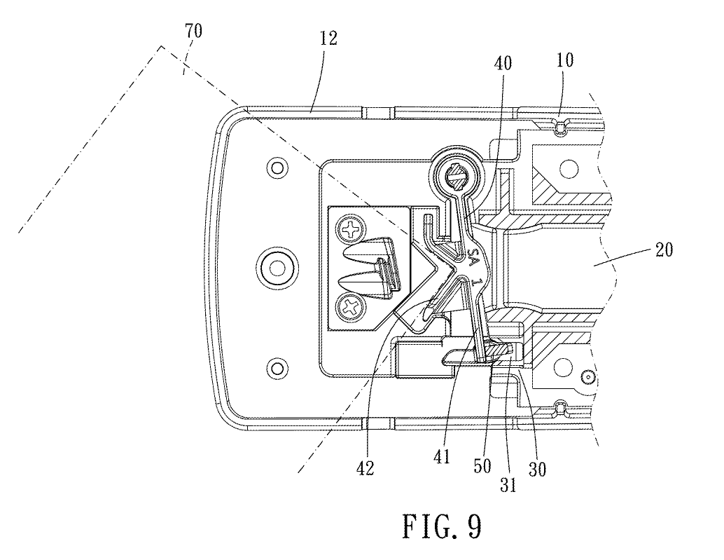

Please refer to FIG. 1 to FIG. 9. The electric stapler of the present invention includes a main body 10, a striking device 20, a photoelectric switch 30, a pivot element 40, and a triggering element 50.

The main body 10 encloses a receiving space and has a front opening 11. The main body 10 has a working platform 12 near the front opening 11. The striking device 21 is arranged in the receiving space and includes a striking mechanism 21 which is movable along the vertical direction. The striking mechanism 21 is movable between an original position and a striking position. The striking mechanism 21 tends to retains at the original position. The striking mechanism 21 has a striking portion 211. The photoelectric switch 30 is arranged in the receiving space of the main body 10 and is connected to the striking device 20. When the photoelectric switch 30 is triggered, the striking mechanism 21 is driven to move to the striking position to allow the striking portion 211 to strike a nail out. An end of the pivot element 40 is pivotally connected to the main body 10 near the front opening, and the other end of the pivot element 40 has a pushing portion 41. The pivot element 40 is closer to the front opening 11 of the main body 10 than the striking portion 211 is. The pivot element 40 has an abutting portion 42 at a face thereof facing to the front opening 11. The pivot element 40 is pivotable between a first position and a second position about a pivot axis. The pivot axis is parallel to the vertical direction. When the pivot element 40 is located at the first position, the pushing portion 41 is closer to the front opening 11. When the pivot element 40 is located at the second position, the pushing portion 41 is more remote from the front opening 11. The pivot element 40 tends to retain at the first position under the elastic force by an elastic member, such as a spring 43. The triggering element 50 is movably arranged between the photoelectric switch 30 and the pushing portion 41 of the pivot element 40. The triggering element 50 is movable between a reset position and a triggering position and tends to retain at the reset position. When the abutting portion 42 of the pivot element 40 is pushed by a papersheet 70, the pivot element 40 is moved toward the second position. And then, the triggering element 50 is moved to the triggering position. When the triggering element 50 is located at the triggering position, the photoelectric switch 30 is triggered.

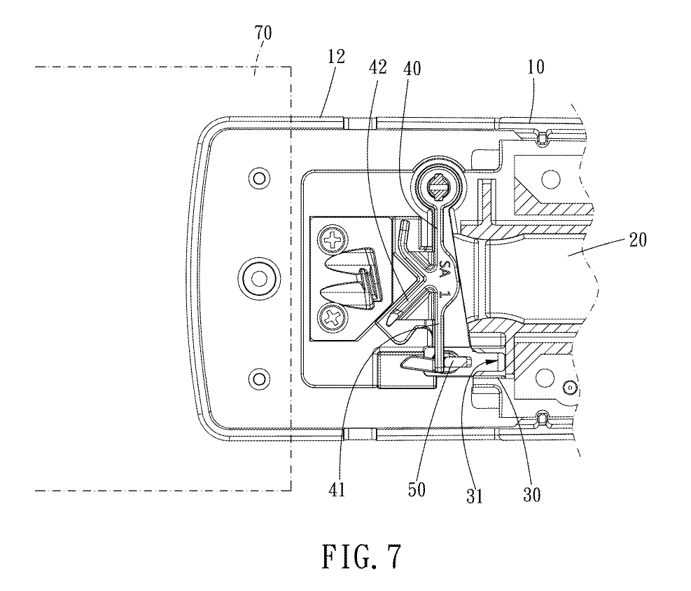

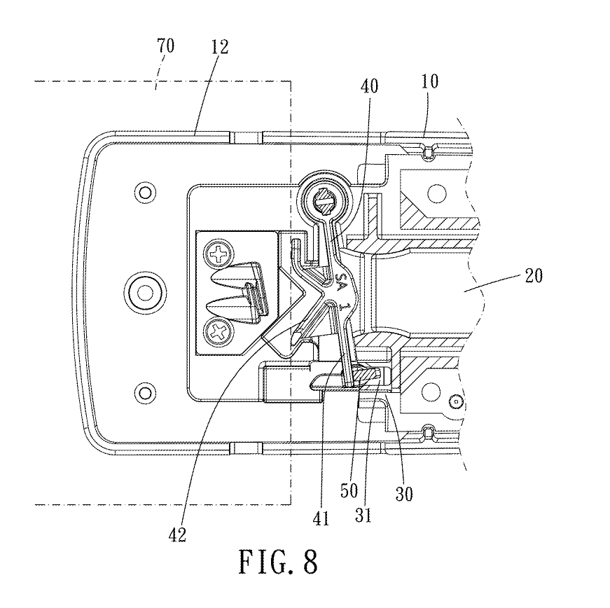

In the present embodiment, the abutting portion 42 has a V-shaped corner facing the front opening 11 of the main body 10. The V-shaped corner is substantially 90 degrees. The V-shaped corner is adapted for a corner of the papersheet 70 to abut against. Preferably, a longitudinal direction is defined by the rear end of the main body 10 and the front opening 11. When the pivot element 40 is located at the second position, the angle bisector of the V-shaped corner is parallel to the longitudinal direction. That is, when the pivot element 40 is pushed to the desired position by the papersheet 70, the nail can be stricken on a corner of the papersheet 70 at 45 degrees. In other words, the nail is perpendicular to the longitudinal direction. Alternatively, an edge of the papersheet 70 abuts against two foot portion of the V-shaped corner to push the pivot element 40, as shown in FIG. 7 and FIG. 8.

Besides, the triggering element 50 further includes an elastic element 51. The triggering element 50 is positioned on the bottom of the main body 10 by the elastic element 51 and tends to retain at the reset position. On the other hand, the photoelectric switch 30 can be a U-shaped photoelectric switch to have a sensing groove 31. A ray is emitted from a lateral wall of the sensing groove 31 and is sensed by the other lateral wall of the sensing groove 31. When the triggering element 50 is located the triggering position, the triggering element 50 is at least partially received in the sensing groove 31 to block the ray. When the photoelectric switch 30 does not sense the ray, the striking device 20 is driven to strike the nail out.

In addition, an elastic guiding element 60 is also included. The elastic guiding element 60 is disposed on the front portion of the striking mechanism 21 and includes a guiding portion 61, an elastic means 62, and a pivot portion 63. The pivot portion 63 is pivotally disposed on the front portion of the striking mechanism 21. The guiding portion 61 extends toward the striking portion 211 and is pivotable up and down. The guiding portion 61 tends to pivot downward due to the elastic means 62. For example, the elastic means abuts against an abutting surface of the front portion of the striking mechanism to provide an elasticity to the guiding portion. When the striking mechanism 21 moves toward the striking position, the guiding portion 61 abuts against the papersheet 70 placed on the working platform 12 so that the guiding portion 61 pivots upward to compress the elastic means 62. Thus, the guiding portion 61 pulls the papersheet 70 toward the striking portion 211 to position the papersheet 70 at the desired position.

In use, the papersheet 70 is inserted into the front opening 11 of the main body 10 with a corner thereof to abut against the abutting portion 42 of the pivot element 40, and the papersheet 70 further pushes the pivot element 40 to the second position to further push the triggering element 50 to trigger the photoelectric switch 30. Thereby, the striking mechanism 21 is driven to move down to strike the nail out.

Because of the mechanism of pivot element 40 and the triggering element 50, the papersheet 70 is able to trigger the stapler more easily. Besides, the V-shaped abutting portion 42 ensures the position of the nail accurate. Also, the papersheet may not be folded or curled.

What is claimed is:

1. An electric stapler, including:
a main body, enclosing a receiving space and having a front opening;
a striking device, arranged in the receiving space and including a movable striking mechanism, the striking mechanism being movable between an original position and a striking position, the striking mechanism tending to retain at the original position, the striking mechanism having a striking portion;
a photoelectric switch, arranged in the receiving space of the main body and connected to the striking device, the photoelectric switch triggering the striking mechanism to move to the striking position to drive the striking portion to strike a nail out when the photoelectric switch is triggered;
a pivot element, an end thereof being pivotally connected to the main body near the front opening, an other end thereof having a pushing portion, the pivot element being more remote from the front opening of the main body than the striking portion is, the pivot portion having an abutting portion at a face thereof facing the front opening, the pivot element being pivotable between a first position and a second position about a pivot axis, the pushing portion being closer to the front opening when the pivot element is located at the first position, the pushing portion being more remote from the front opening when the pivot element is located at the second position, the pivot element tending to retain at the first position due to an elastic force of an elastic member;
a triggering element, being movably arranged between the photoelectric switch and the pushing portion of the pivot element, the triggering element being movable between a reset position and a triggering position, the triggering element tending to retain at the reset position, the triggering element being pushed to move toward the triggering position when the abutting portion of the pivot element is pushed by a papersheet and the pivot element is moved toward the second position, the triggering element triggering the photoelectric switch when the triggering element is located at the triggering position.

2. The electric stapler of claim 1, wherein the abutting portion of the pivot element has a V-shaped corner facing the front opening of the main body, the V-shaped corner is substantially 90 degrees, the V-shaped corner is adapted for a corner of a papersheet to abut against.

3. The electric stapler of claim 2, wherein a longitudinal direction is defined by a rear end of the main body and the front opening of the main body, an angle bisector of the V-shaped corner is substantially parallel to the longitudinal direction.

4. The electric stapler of claim 1, wherein the elastic member is a spring.

5. The electric stapler of claim 1, wherein the triggering element includes an elastic element, the triggering element is positioned on a bottom of the main body by the elastic element and tends to retain at the reset position.

6. The electric stapler of claim 1, wherein the photoelectric switch has a sensing groove, a ray is emitted from a lateral wall of the sensing groove and is sensed by an opposite lateral wall of the sensing groove, the triggering element is at least partially received in the sensing groove to block the ray when the triggering element is located at the triggering position.

7. The electric stapler of claim 1, further including an elastic guiding element, the elastic guiding element being located in front of a front portion of the striking mechanism, the elastic guiding element includes a guiding portion, an elastic means, and a driving portion, the driving portion being pivotally disposed on the front portion of the striking mechanism, the guiding portion extending toward the striking portion and being pivotable up and down, the guiding portion tending to pivot downward due to the elastic means, the main body having a working platform near the front opening, the guiding portion abutting against the papersheet placed on the working platform so that the guiding portion pivot upward to compress the elastic means and that the guiding portion further pulls the papersheet toward the striking portion.
